(19) United States
(12) Patent Application Publication
(10) Pub. No.: US 2004/0003697 A1
(43) Pub. Date: Jan. 8, 2004

(54) Headbox holder adapted for holding a headbox for cutting

(76) Inventors: Hsi-Hui Nien, Changhua (TW); Ching-Chuan Huang, Changhua (TW)

Correspondence Address: BACON & THOMAS, PLLC, 625 SLATERS LANE, FOURTH FLOOR, ALEXANDRIA, VA, 22314

(21) Appl. No.: 10/189,524

(22) Filed: Jul. 8, 2002

(51) Int. Cl. B26D 7/02; B23D 7/00

(52) U.S. Cl. 83/465; 83/467.1; 83/746

(57) ABSTRACT

A headbox holder for use with a saw blade to cut a headbox for vertical blind according to the desired length is disclosed to include a main body, a mounting base extended outwards from the bottom side of the main body and adapted for supporting the main body on a worktable, an insertion slot extended through the front and back sides of the main body and adapted for receiving the headbox to be cut, a vertical cutting slot formed in the main body and vertically extended across the insertion slot for receiving the saw blade for cutting the headbox being inserted through the insertion slot.

### BACKGROUND OF THE INVENTION

1. Field of the Invention

The present invention relates to blind installation and, more specifically, to a headbox holder adapted for holding a headbox for enabling the headbox to be cut with a saw blade according to the desired length.

2. Description of the Related Art

Regular commercially available vertical blinds are made subject to a set of sizes to fit standard windows. These vertical blinds are called sized vertical blinds. However, there are buildings having particularly designed windows. Regular sized vertical blinds do not fit these particularly designed windows. To fit these particularly designed windows, custom-made blinds shall be used. However, custom-made blinds are commonly expensive. Further, it takes much time to fabricate blinds of particular specifications. In order to save the cost, consumers may purchase sized blinds from the market, and then cut the sized blinds according to the desired lengths. However, because the headbox of a regular blind is extruded from aluminum or the like, it is not easy to cut the headbox according to the desired length. When using a bench vise or the like to hold down the headbox for cutting, the clamping force of the bench vise may deform the headbox. Further, because most consumers have little experience in cutting metal device, it is difficult to keep the cut side of the headbox smooth.

### SUMMARY OF THE INVENTION

The present invention has been accomplished under the circumstances in view. It is one object of the present invention to provide a headbox holder, which is practical for holding any of a variety of headboxes for blind positively in position for cutting.

It is another object of the present invention to provide a headbox holder, which is practical for use with a saw blade to cut a headbox for blind conveniently smoothly according to the desired length.

To achieve these objects of the present invention, the headbox holder comprises a main body, a mounting base extended outwards from a bottom side of the main body and adapted for supporting the main body on a worktable, an insertion slot extended through the front and back sides of the main body and adapted for receiving a headbox to be cut, a vertical cutting slot formed in the main body and vertically extended across the insertion slot for receiving a saw blade for cutting the headbox being inserted through the insertion slot.

### BRIEF DESCRIPTION OF THE DRAWINGS

FIG. 1 is a perspective view of a headbox holder according to a preferred embodiment of the present invention.

FIG. 2 is a side view in section of the headbox holder according to the preferred embodiment of the present invention.

FIG. 3 shows an application example of the headbox holder according to the preferred embodiment of the present invention.

FIG. 4 shows an alternate application example of the headbox holder according to the preferred embodiment of the present invention.

### DETAILED DESCRIPTION OF THE PREFERRED EMBODIMENT

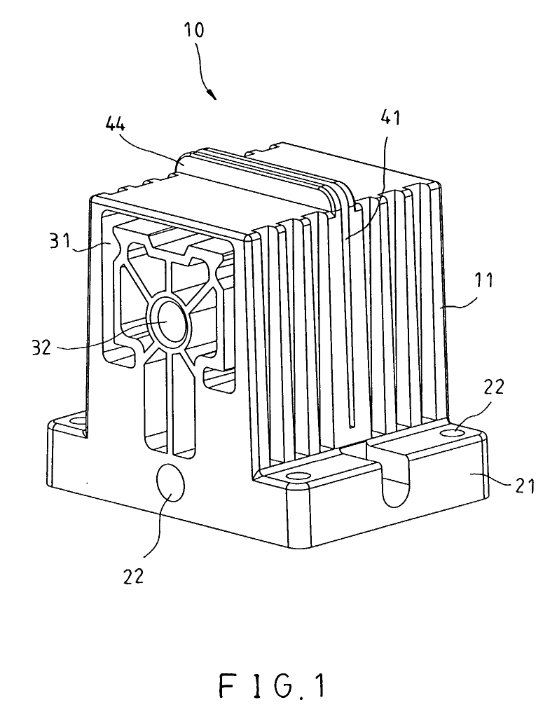

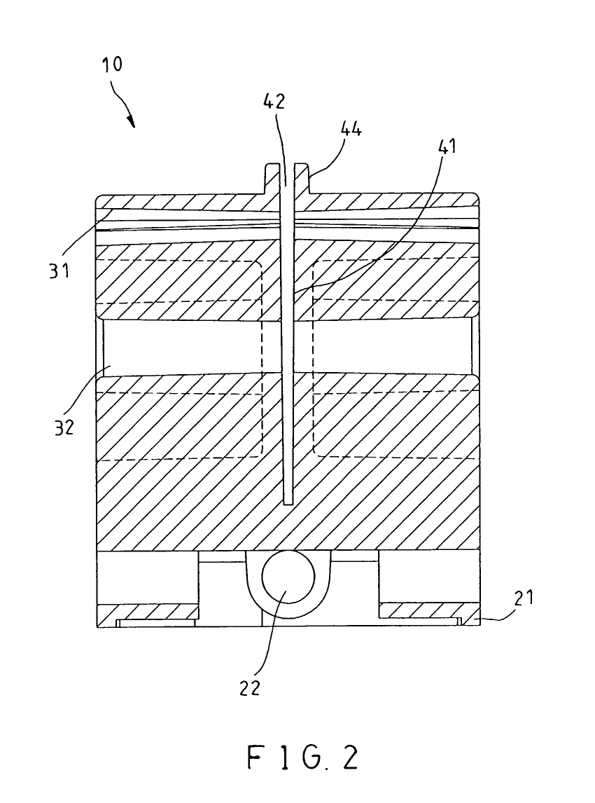

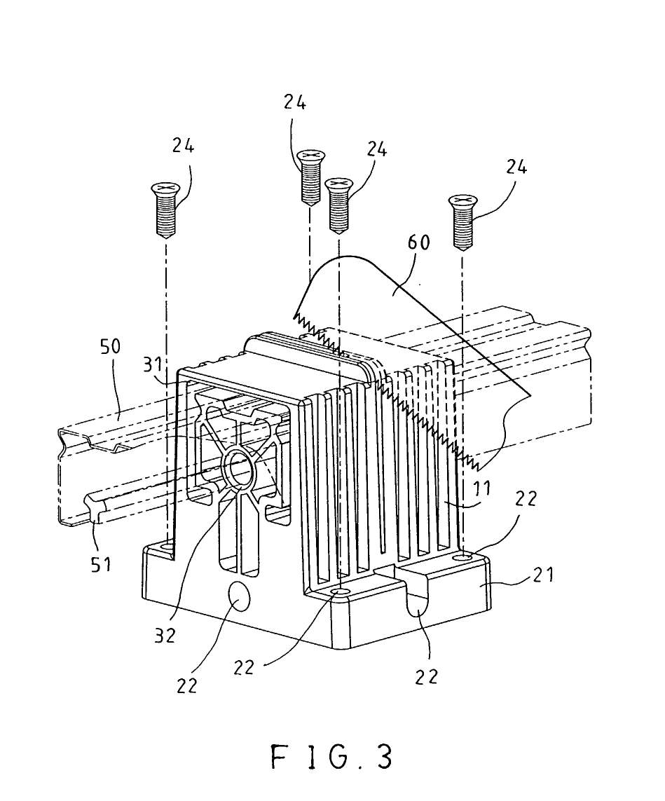

Referring to FIGS. 1 and 2, a headbox holder 10 is shown adapted for holding a headbox for vertical blind for enabling the headbox to be cut according to the desired length. The headbox holder comprises a substantially rectangular main body 11 molded from hard plastics, a mounting base 21 extended outwards from the bottom side of the main body 11 and adapted for supporting the main body 11 on a worktable (not shown), a plurality of mounting holes 22 formed in the mounting base 21 for the mounting of screws 24 (see also FIG. 3) to fix the mounting base 21 to the worktable, a circular through hole 32 extended through the front and back sidewalls of the main body 11 and adapted for receiving the longitudinal center axle of the headbox to be cut, an insertion slot 31 of substantially inverted U-shaped cross-section extended through the front and back sidewalls of the main body 11 around the circular through hole 32 and adapted for receiving the headbox to be cut, a vertical cutting slot 41 formed in a middle part of the main body 11 and vertically extended across the insertion slot 31 to the top and adapted for receiving the saw blade to be used, and two stop flanges 44 protruded from the top sidewall of the main body 11 at two sides of the top open side 42 of the vertical cutting slot 41 and adapted for guiding cutting action of the saw blade.

Referring to FIG. 3, the mounting base 21 of the headbox holder 10 is fixed to the worktable (not shown) by screws 24, and then the headbox 50 to be cut is inserted through the insertion slot 31 of the headbox holder 10, keeping the center axle 51 of the headbox 50 extended through the circular through hole 32 of the headbox holder 10, and then adjust the position of the headbox 50 in the insertion slot 31 of the headbox holder 10 according to the length to be cut, and then insert the saw blade 60 into the top open side 42 of the cutting slot 41 and reciprocate the saw blade 60 to cut the headbox 50. During reciprocating cutting action of the saw blade 60, the stop flanges 44 prevent vibration of the saw blade 60. When the saw blade 60 passed to a middle part of the cutting slot 41 during cutting action, the width of the cutting slot 41 keeps the reciprocating cutting action of the saw blade 60 in a straight course. Therefore, the consumer can cut the headbox 50 according to the desired length smoothly. When well cut, the cutting side of the headbox 50 is maintained smooth without destroying the sense of beauty of the headbox 50.

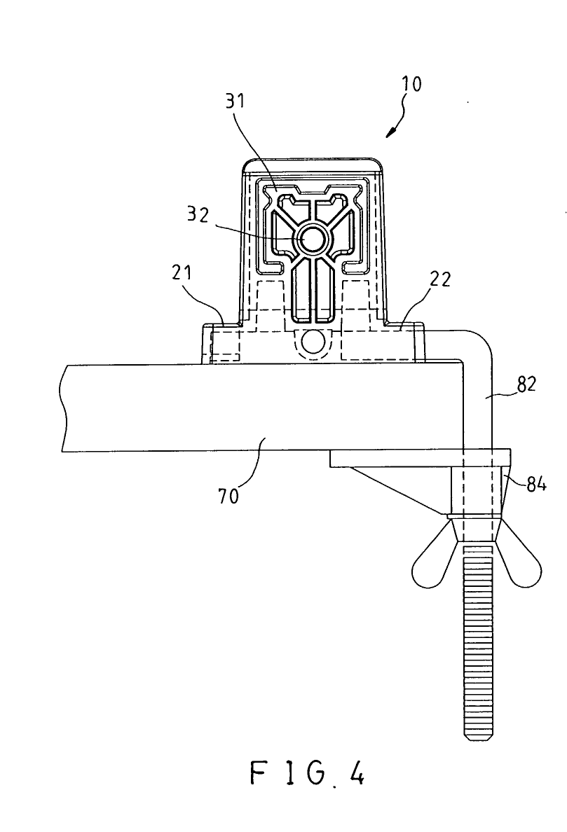

FIG. 4 shows an alternate form of the present invention. According to this alternate form, the mounting base 21 of the headbox holder 10 is provided with a mounting assembly formed of a screw bolt 82 and a packing nut 84. By means of the screw bolt 82 and the packing nut 84, the headbox holder 10 can firmly be fastened to the worktable 70 without damaging the surface of the worktable 10.

As indicated above, the present invention provides a headbox holder, which is practical for holding any of a variety of headboxes for vertical blind, for enabling the consumer to cut the headbox according to the desired length conveniently without destroying the sense of beauty of the headbox.

What is claimed is:

1. A headbox holder for use with a saw blade to cut a headbox for vertical blind, the headbox holder comprising a main body, said main body having a top side, a bottom side, a front side, and a back side, a mounting base extended outwards from the bottom side of said main body and adapted for supporting said main body on a worktable, an insertion slot extended through the front and back sides of said main body and adapted for receiving the headbox to be cut, a vertical cutting slot vertically extended across said insertion slot and adapted for receiving the saw blade for cutting the headbox being inserted through said insertion slot.

2. The headbox holder as claimed in claim 1, wherein said mounting base comprises at least one mounting hole for the mounting of a respective fastening element to fix said mounting base to the worktable.

3. The headbox holder as claimed in claim 1, wherein said main body has a circular center through hole extended through the front and back sidewalls thereof.

4. The headbox holder as claimed in claim 1, wherein said cutting slot is vertically extended from the top side of the main body toward the bottom side of the main body, wherein said main body comprises two stop flanges protruded from the top side thereof at two sides of said vertical cutting slot.
